(19) United States
(12) Patent Application Publication
(10) Pub. No.: US 2014/0054525 A1
(43) Pub. Date: Feb. 27, 2014

(54) Pipe Travelling Apparatus and Use Thereof

(71) Applicants: Johannes Gerhardus Spijker, Dedemsvaart (NL); Klaas Alexander Nicolai, Dedemsvaart (NL)

(72) Inventors: Johannes Gerhardus Spijker, Dedemsvaart (NL); Klaas Alexander Nicolai, Dedemsvaart (NL)

(73) Assignee: JELCER-IP B.V., Dedemsvaart (NL)

(21) Appl. No.: 13/981,743

(22) PCT Filed: Jan. 25, 2012
(86) PCT No.: PCT/NL2012/050039

§ 371 Date: Oct. 14, 2013

(30) Foreign Application Priority Data
Jan. 25, 2011 (NL) 2006062
Jan. 25, 2011 (NL) 2006064

(51) Int. Cl. H02G 1/08; B61B 13/10; F16L 55/00

(52) U.S. Cl. CPC H02G 1/088; F16L 55/00; B61B 13/10
USPC 254/134.3 R; 104/138.2

(57) ABSTRACT

The pipe travelling apparatus (100) for travelling through a curved sewerage pipe and for performing a task in said pipe comprises a first segment (101) and a second segment (102), each comprising a body (101, 102) provided with a sliding surface (108, 109) for sliding along an inner bottom surface of a pipe, said first and second segment mutually coupled by a bendable coupling member (120). The apparatus further comprises a tool (161, 150, 171, 172) suitable for performing said task in the pipe and provided in or to at least one of said first segment (101) and said second segment (102). The apparatus further comprises a driving means (130) coupled to said first and/or second segment (101, 102), such as a driving cable. The pipe travelling apparatus (100) is intended for transportation of a cable (90) into the pipe, and for fastening cable fastening elements (10) attached to said cable (90) to an inner wall of said pipe.

### FIELD OF THE INVENTION

The invention relates to a pipe travelling apparatus for transportation and fastening of cable fastening elements. The invention further relates to use of such pipe travelling apparatus for transportation and fastening of cable fastening elements to desired longitudinal positions in a pipe, particularly a curved sewerage pipe.

### BACKGROUND OF THE INVENTION

Pipe travelling apparatus for use in sewerage systems, such as sewer and drain pipes, are well known. Such apparatus is typically used for inspection and/or rehabilitation of the sewer pipe. Various types of apparatus exist, including versatile apparatus suitable for accommodation of curves and corners that may be present particularly in drain pipes. In the context of the present application, the term ‘sewer pipe’ is used for a duct of pipe extending along a street. The term ‘drain pipe’ is used for a duct or pipe extending from an individual building into said sewer pipe. Such drain pipe will also be referred to as a branch pipe. It will be clear to the skilled person that the sewer pipe typically has a larger diameter than a drain pipe. The term ‘curved sewerage pipe’ is used to refer both a drain pipe and to any other curved canalisation pipe suitable for use in the invention.

One example of such versatile pipe travelling apparatus is for instance known from U.S. Pat. No. 4,770,105. This known pipe travelling apparatus comprises a plurality of body mutually coupled by means of coupling frames, such as flexibles joints or universal joints. These coupling frames allow the relative position and orientation of adjacent frames to vary, which enables the pipe travelling apparatus to pass corners and curves. Each body is provided with a first and a second section mutually connected in elastic manner, for instance springs, so that may be extended. In such manner one of the sections of such body is radially displaced in the pipe. Each section is provided with a thread. The displacement of the section ensures that at least one of the sections has a thread in contact with a wall. The contact of the wall ensures that the apparatus can travel within the pipe. Biasing means are provided in the form of coil springs, magnets for ensuring the contact at all times between the thread that drives the apparatus and the inner wall. The apparatus is particularly intended for inspection. A further example of a versatile pipe travelling apparatus is known from FR2660730A1. This patent application discloses a specific embodiment of a coupling frame. This frame comprises a first and a second shaft connected over a hinge point, around which the first and second shaft, as well as the bodies coupled thereto may pivot with respect to each other. Such pivoting allows the apparatus to accommodate in curves and move around obstacles. The shafts may be varied in length. The combined presence of a bending point and a shaft variable in length is exploited in that movement of the pipe travelling apparatus by means of reputation is achieved. The apparatus is particularly intended for inspection.

Another less versatile example of a pipe travelling apparatus is provided by EP840869B1. This patent discloses a vehicle with a plurality of linked modules forming a powered train for travelling within a pipe. A module comprises a clamping means for holding the vehicle at a fixed point in the pipe, whilst rotational means are operable to axially rotate part or parts of the vehicle. The rotational movement may be used for carrying out a specific operation, such as boring.

Recently, it has been envisaged to lay cables into the sewer pipe and the drain pipes, particularly for connecting individual building to a high speed communication network, such as a glass fibre network. Typically, two different methods are known for the fastening of the cable into the pipe, preferably in a top section of the pipe where the cable will lead to minimum obstruction to any slurry flowing in such pipes. A first method involves the use of means covering the inner surface of a pipe. Examples hereof are socks, f.i. of elastic material, and/or an adhesive or an encapsulating material. A second method involves the provision of cable fastening elements in the pipe to support and fix the cable, and is known for instance from EP1868020 and DE19813728. The fastening elements according to DE19813728 may be inserted into the sewerage system separately from the cable, using a travelling apparatus with a storage. The fastening elements according to EP1868020 have been attached to the cable prior to its insertion into the sewerage system. However, these known apparatuses and insertion methods are only suitable for use in the sewer pipe rather than in drain pipes.

The provision of cables and/or their fastening with such cable fastening elements in drain pipes leads to particular problems for the design of a pipe travelling apparatus. As will be clear, the shape of drain pipes is typically curved, and furthermore often differs from building to building. A first problem is that the transport of a cable reduces versatility of the pipe travelling apparatus. The intended glass-fibre cables are typically vulnerable and could for instance break or be folded upon a drastic movement of the apparatus. A second issue is the space in the apparatus required for transport and/or position of said cable and/or cable fastening elements. If the travelling apparatus completely fill up a section of the pipe, there will not be any space left for the transport of the cable and/or cable fastening elements. A third issue is the fixation of the cable fastening elements. The desired fixation of cable fastening elements in the top-section of the pipe requires an adequate orientation of the apparatus throughout the drain pipe, so as to bring all fastening elements in the top section.

Therefore, there is still a need for an improved pipe travelling apparatus that is suitable for transportation of a cable in a drain pipe particularly, but optionally also in sewer pipes or any other canalisation pipe likely including curves and corners (i.e. the apparatus should be able to accommodate curves and corners so as to be useful in all pipes in a piping network).

There is a further need for an improved pipe travelling apparatus suitable for positioning of cable fastening elements in drain pipe.

There is moreover a need for an improved method of introduction and positioning of a cable into a sewerage system, particularly into a curved pipe, such as a drain pipe.

### SUMMARY OF THE INVENTION

According to a first aspect, a pipe travelling apparatus for travelling through a curved sewerage pipe and for performing a task in said pipe is provided, said apparatus comprising:
a first segment and a second segment, each comprising a body provided with a sliding surface for sliding along an inner bottom surface of a pipe, said first and second segment mutually coupled by a bendable coupling member;
a tool suitable for performing said task in the pipe and provided in or to at least one of said first segment and said second segment;
a driving means coupled to said first or second segment. This driving means suitably is in the form of a driving cable.

According to a second aspect, use of the pipe travelling apparatus according to the invention for performance of a task at a predefined location in a curved sewerage pipe is provided. The performed task is more particularly the transportation and/or fastening of a cable with cable fastening elements to desired longitudinal positions in such a pipe.

According to a third aspect, a system of a pipe travelling apparatus and a cable preferably provided with cable fastening means is provided. The system is designed for transportation of the cable into a curved sewerage pipe. Thereto the pipe travelling apparatus comprises a cable holding means, preferably with retaining means for a block on or attached to said cable. More preferably the cable is provided with a first and a second block at different longitudinal positions, such as in and outside a tip section, and the retaining means can be rearranged and/or relocated from an active configuration into a non-operative configuration. As a result, the tip section of the cable may be transported into areas where the pipe travelling apparatus itself cannot go. The pipe travelling apparatus is furthermore provided with means for accommodating curves in the curved sewerage pipe, and is more preferably also capable of moving over ridges and through (i.e. out of) holes in the inner wall of the sewerage pipe, which may exist. Such means are most preferably constituted in that the pipe travelling apparatus comprises the construction as claimed in claim 1, although alternatives are not excluded. According to a fourth aspect, another system of a pipe travelling apparatus and a cable with cable fastening means is provided. This system is designed such that the pipe travelling apparatus may position the cable fastening means by bringing them from a transport configuration into a fastening configuration attached against a wall of the curved sewerage pipe. Preferably, the means are constituted by a knife intended for cutting a rope.

According to a fifth aspect, a method of transporting and optionally positioning a cable into a curved sewerage pipe is provided. Herein, a first block is attached to the cable in a tip section and a second block to the cable at a location further away from the tip section. Provided is a pipe travelling apparatus comprising means for accommodating curves in said pipe, such as the construction claimed in claim 1, and further comprising a cable holding device provided with retaining means for a block attached to the cable. Then the cable is loaded onto the pipe travelling apparatus, such that the first block rests against the retaining means of the cable holding device. The pipe travelling apparatus is thereafter introduced together with the cable into the curved sewerage pipe, and is moved forward through the pipe, so that the cable is transported into the curved sewerage pipe. Subsequently, the retaining means of the cable holding device are rearranged from an active to a non-operative configuration, so that the pipe travelling apparatus may pass the second block during backward movement. The pipe travelling apparatus is moved backwards, such that the first block becomes free of the cable holding device, and is left in its position, and up to a position wherein the second block is in front of the cable holding device. The retaining means are thereafter arranged and/or located back from its non-operative into its active configuration. The pipe travelling apparatus is then moved forwards, wherein the retaining means push against the second block, and the tip section of the cable is transported further to a location where the pipe travelling apparatus itself cannot go.

The segments of the pipe travelling apparatus of the invention are provided with a body having one or more sliding surfaces, rather than wheels, continuous treads, rails or the like as used in the prior art. These sliding surfaces have more flexibility in accommodating to a curve than wheels or the like, such the travelling apparatus leaves sufficient space for cable and/or cable fastening elements. For reasons of simplicity, the body of the first segment will hereinafter also be referred to as the first body. The body of the second segment will hereinafter also be referred to as the second body.

Preferably the sliding surface of the first body extends both axially and radially, as defined with reference to the pipe. From the two axial directions, the sliding surface extends then to the front side of the first body. The term front side of the first body is in the present context understood as the side constituting the front side when the apparatus is travelling forward. Such an extension of the sliding surface makes that the apparatus has minimum risk of getting stuck around an obstacle or in a curve in the pipe. More preferably, the sliding surface of the second body also extends both axially, in on the front side, and radially, as defined with reference to the pipe.

Most preferably the sliding surfaces of the first and the second bodies extend axially in both directions, i.e. to the front side and to the rear side. As a result thereof, the apparatus may be moved both in forward and in backward direction, i.e. be pushed and drawn. This turns out a major advantage for use of the apparatus in drain pipes. A drain pipe often comprises a portion extending substantially vertically, which ends into the sewer pipe. If the apparatus would travel into such a portion, it would fall down, and be damaged or damaging the sewer pipe or elements therein. These consequences are easily avoided in that the apparatus travels forward and backward within the drain pipe. The sliding surface is suitably curved and could have a cylindrical shape, or at least part thereof, for instance extending over 90 to 270 degrees, (when the cylinder is seen in a cross-sectional view parallel to said front side). The sliding surface on the front side and optionally on the rear side may then constitute a separate face. Rather than purely cylindrical, the shape could be substantially cylindrical. For instance the sliding surface at a bottom part of the body could be widened, so as to obtain a kind of (rowing) boat shape.

Rather than that the sliding surface in axial direction and radial direction forms two or more separate sliding surfaces, the sliding surface could be continuous. Then, the sliding surface has an ovate or spherical form, more particularly a hemispherical, or hemi-ovate form, which is moreover a very simple form.

The bendable coupling member is suitably embodied as an assembly of a first and a second shaft mutually coupled via a hinge point. The first shaft is herein suitably fixed to or part of the first segment, and the second shaft is suitably fixed to or part of the second segment. Preferably, the first and second shafts are rigid, so that the movement induced by the drawing cable is transmitted from the second to the first body via said shafts and directly. The first shaft is advantageously connected to the first body, and the second shaft is connected to the second body. It is considered beneficial that the first shaft is fixed to or integrated in the first body at its upper side. More particularly, the shaft may extend over the first body and constitute an upper plate on top of which tools may be positioned. The shaft may further be locked into the body mechanically, rather than or in addition to being secured chemically and or with separate elements (nails, screws and the like). The same preference holds for the second shaft. The term ‘hinge point’ is used herein is intended to cover any known connection under which a first and a second shaft may acquire mutually different orientations. Rather than a conventional hinge, use could for instance be made of a drawing hook and a complementary grip for the coupling of the first and the second shafts.

Most preferably, the first shaft has a length different from the second shaft, such that the hinge point is not in the middle between the first and the second segment. In a suitable implementation, the first shaft is longer than the second shaft. This asymmetrical orientation of the hinge point turns out to have a beneficial effect on the accommodation of the travelling apparatus through curves within the pipe.

In a suitable embodiment, the first and second body each contain a stabilization mass. Such a stabilization mass ensures not merely a correct position of the apparatus in the pipe, but is moreover contributes to the accommodation of the apparatus in curves and with respect to obstacles. With the stabilization mass, the apparatus has a sufficient impulse, and hence a tendency to continue movement. The moving mass of the second body may when the first body would get stuck push the first body forward. The moving mass furthermore allows to pass a ridge, or to get out of a hole in the inner wall (particularly the bottom) of the pipe. Preferably, the body is substantially massive and comprises a metal or an alloy. The body may alternatively be hollow but filled with a material. Lead and steel are considered suitable examples of dense metals and alloys. The body wall is suitably hard, so as to prevent deformation of the material when butting against obstacles, going out of holes etc. It is more preferably highly for attack by acid, base, bacteria and any other corrosive compounds that may be present in sewerage systems.

Furthermore, a running wheel for running against a top portion of the inner wall is suitably coupled to the first body. The coupling is more preferably an elastic coupling, for instance embodied as a spring. Such a running wheel ensures a correction orientation of the apparatus within the pipe. The wheels may be driven by a motor and be designed for setting the speed of the apparatus. The running wheel could be provided with a continuous tread. Alternatively or additionally, the travelling apparatus may be pushed or drawn by means of its driving cable, which thereto would be embodied as a rather stiff cable.

In a further embodiment, the first and/or second segment is provided on its upper side with a cable holding device provided for instance a guiding means and/or retaining means. Examples include a clamp, a slit, a sleeve, a groove, an eye, an eye with an opening slit and the like, as will be apparent to the skilled person. More preferably, the cable itself is provided with a block of a size larger than said eye. The cable holding device then comprise or form retaining means for the said block on the cable and may additionally comprise or form guiding means for the cable as a whole. Under travelling or movement of the pipe travelling apparatus in the forward direction, the cable will then be pushed forward. However, when the pipe travelling apparatus is moved in the backward direction, the cable is not pushed backwards, but rather remains in the pipe.

More preferably, in operation, a block may be located along the cable such that a tip portion of the cable will extend into the sewer pipe, when the travelling apparatus is still in the drain pipe (and even in view of the not-accessible vertical portion of the drain pipe). In order to prevent damage to said extending tip portion, this tip portion of the cable may be provided with a block as well. This implementation has several advantages. First, the block on the tip portion allows that a further apparatus in the sewer pipe may pick up the cable easily.

Secondly, the subsequent blocks allow a two (or more) phase transportation of the cable in that the cable holding device pushes first against the (first) block in the tip portion of the cable, as far as it can go in the drain pipe. The travelling apparatus will thereafter travel backwards until it passes another block. Then the travelling apparatus will pick up the block and reverse its travelling direction, so as to bring the second block as far as it is able to. The first block in the tip section will therewith be brought forward into the sewer pipe. Thereafter the cable can be drawn further.

In connection with this intended and preferred use, the cable holding device is movable, so as to allow that the cable holding device passes the second block when the apparatus travels backwards in the pipe. Any type of movement is appropriate, as long as the cable holding device is moved out of the path of the second block. In a suitable implementation, the cable holding device can be rotated, particularly between a horizontal and a vertical orientation. Thereto, the cable holding means most suitably comprise cable guiding means such as a slit, acting also as retaining means. Alternative implementations are however by no means excluded.

In alternative and or further embodiment, the pipe travelling apparatus is provided with positioning means for cable fastening elements. In one most suitable embodiment, the apparatus with the cable holding device further comprises such positioning means. Alternatively, the cable holding device and the positioning means are embodied in distinct apparatuses.

Preferably, use is made of cable fastening elements that have been pre-fixed to the cable before insertion of the cable into the drain pipe. Such elements typically are kept in a transport configuration during transport. For instance two oppositely extending legs are kept together. These legs will move outwards once free to do so under their internal elastic force, and then press against the inner surface of the pipe. Alternatively, the fastening elements are brought from their transport to their final configuration by rotating from a primarily horizontal orientation to a vertical orientation.

In a most preferable solution according to the invention, use is made of fastening elements that are kept together by means of a rope. The second segment of the pipe travelling apparatus is provided with a cutting tool at its rear side, so that during backward travelling of the travelling apparatus the cutting tool will cut the rope. The legs of the fastening element will then move outwards and press against the inner wall of the pipe. This outward movement additionally enables that the travelling apparatus can pass through the cable fastening element.

Furthermore, the travelling apparatus of the invention suitable comprises an inspection tool both on its first body for viewing into the front direction, and an inspection tool on its second body for viewing into the rear direction. It will be understood that a lamp may be added to the inspection tool. The inspection tool is for instance a camera for visual inspection, but could additionally or alternatively be a tool for infrared, UV, X-ray, ultrasound inspection. Images are preferably coupled to data processor by means of a communication cable, suitably included into the driving cable. GPS functionality may be available so as to monitor the position of the pipe travelling apparatus remotely.

### BRIEF INTRODUCTION OF THE FIGURES

These and other aspects of the pipe travelling apparatus of the invention and the use thereof will be further elucidated with reference to the Figures in which:

FIG. 1a-1e shows in diagrammatical cross-sectional view a sequence of stages of the cable insertion method in accordance with the invention;

FIG. 2A shows in diagrammatical side view a robot with lasso tool

FIG. 2B shows in diagrammatical top view the robot of FIG. 2A;

FIG. 3A shows in a diagrammatical view a first cable fastening element in its transport configuration;

FIG. 3B shows in a diagrammatical view the cable fastening element of FIG. 3A, wherein the fastening element is in its fastening configuration;

FIG. 4 shows in diagrammatical top view the cable fastening element of the invention in a second embodiment;

FIGS. 5A and 5B show in diagrammatical view the cable fastening element of FIG. 4 in the fastening configuration and the transport configuration;

FIG. 6 shows in diagrammatical view the pipe travelling apparatus according to a first embodiment of the invention;

FIG. 7A shows in cross-sectional diagrammatical view the pipe travelling apparatus according to a second embodiment of the invention;

FIG. 7B shows the pipe travelling apparatus according to FIG. 7A in a bird's eye perspective, further including a cable with a cable fastening element

FIG. 8A shows a front side view of the pipe travelling apparatus according to FIG. 7A, and

FIG. 8B shows a rear side view of the pipe travelling apparatus according to FIG. 7A.

### DETAILED DESCRIPTION OF ILLUSTRATED EMBODIMENTS

The Figures are not drawn to scale and equal reference numerals in different Figures refer to equal or similar elements. The sewer pipe is also referred to as the main pipe. The drain pipe will also be referred to as a branch pipe. The cable fastening element is also referred to as a clip. The pipe travelling apparatus is also referred to as a robot.

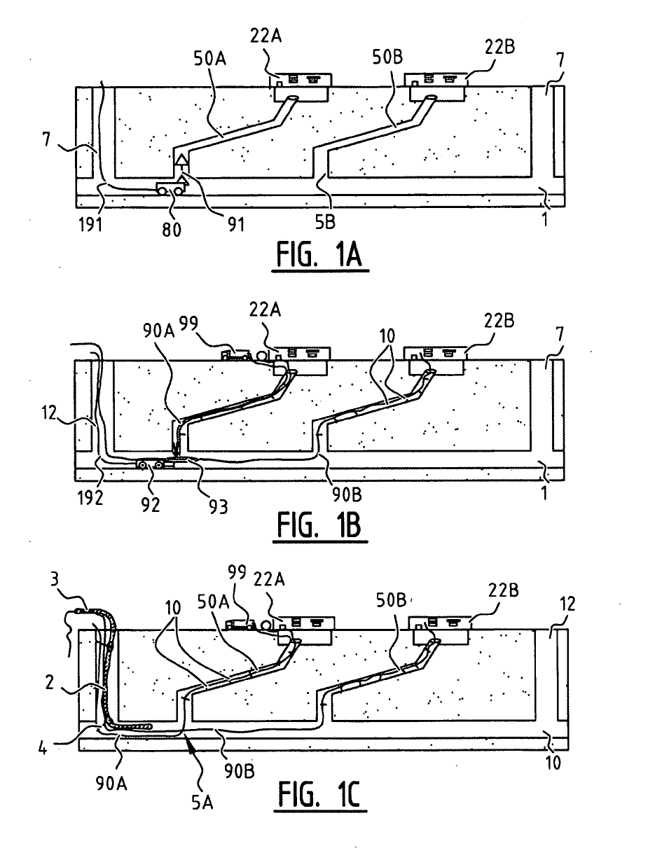

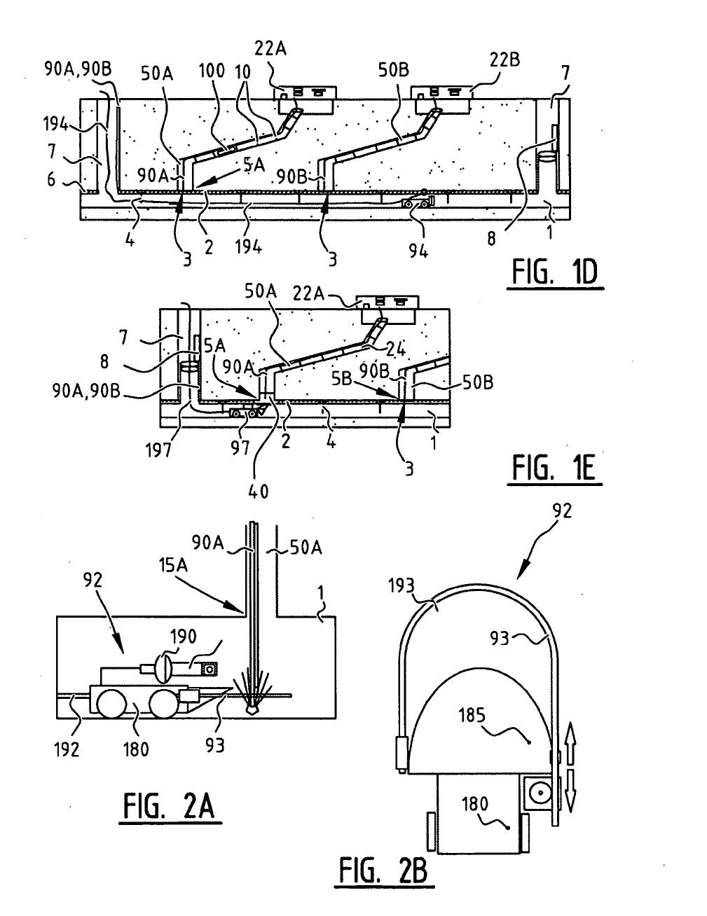

FIG. 1a-e show in diagrammatical views five stages of the method of the invention. This method comprises the provision of a first cable 90A and second cable 90B from individual buildings 22A, 22B to a central access point 7. The central access 7 is typically a pipe that is accessible from a street. The path runs through a main pipe 10 and a first branch pipe 20A and a second branch pipe 50B. While the main pipe 1 is herein shown to be a single pipe, it is not excluded that the main pipe corresponds to a pipe system in one embodiment. Generally, the main pipe 10 and the first and second branch pipes 50A, 50B are part of a sewerage system. It will be seen that the shown method comprises the provision and the positioning of individual cables. In one embodiment, the signals from and to the first cable 90A and second cable 90B may be transported to a further transmission system from the access point 7. This further transmission system could be wireless or wired. If wired, it could again make use of the sewerage system or make use of a cable network provided separately. Any electronic conversion may occur at the access point 7, so as to improve signal integrity and reduce losses, as will be known to the skilled person in the relevant art. The optical cable is intended to be for use for the transmission of telecommunication signals, such as telephone and fax, internet connections, and broadcast signals. Use for the transmission of further signals is not excluded. While the specific embodiment of the method is preferred, it is to be understood that alternatives may be envisaged, and the focus of the present invention is particularly on the step shown in FIG. 1E. FIG. 1A shows a first step of the method in which the main pipe 1 and the first and second branch pipe 50A, 50B are inspected. Use is made of an inspection robot. The robot 80 is provided with camera, positioning means and other electronic inspection equipment. The robot 80 is coupled over a cable 191 to a monitoring system, for instance a computer or even a telecommunication connection to a central database. It is understood that a cable connection 191 is preferred over a wireless connection in view of the underground location of the main pipe 1 and the branch pipes 50A, 50B. The cable connection 191 may further provide energy to the robot 80, but this is not necessary or preferred. Typically, the robot will be provided with a motor that is driven with a local battery or with a combustion engine as known to the skilled person. Inspection robots 80 for use in underground locations and also in sewerage systems are known per se, for instance from FR2660730. Specifically, the inspection robot 80 further comprises a tool 91 for inspection of branch pipes 50A, 50B. Thereto, the said tool is provided on a shaft that is telescopic so as to enable inspection along the full length of a branch pipe 50A, 50B. The inspection step is to provide information as to the length of a cable to be provided from building 22A to the access point 12, as well as to identify areas at which it is not feasible to provide clips to the first cable 90A. Furthermore, general information in relation to the sewerage system may be gathered, particularly in relation to the type of sewerage system as well as the actual state thereof.

FIG. 1B shows a second stage in the method of the invention, in which a first cable 90A is provided from the building 22A into the first branch pipe 50A and then through the entrance 5A into the main pipe 1 so as to arrive at the access point 7. Use is made of a truck 99 that provides the first cable 90A. It enters the first branch pipe 50A at the side of the building 22A, typically just outside the building 22A or below the building 22A. In the event that the building comprises a plurality of apartments and/or offices and/or other units, a plurality of first cables 90A could be provided. Suitable, such plurality of signal cables is then put together into one or more physical cables.

Alternatively, some electrical integration so as to modulate signals in different frequency bands in one cable may be applied if desired and/or necessary. It is herein preferred that the number of first cables 90A entered into the first branch pipe 50A remains limited, while the first cable 90A remains sufficiently flexible so as to accommodate through curves and around corners. In one further embodiment, a first cable 90A provides a plurality of individual signal cables. Such cable multiplication may be provided for future use, for instance in case of the need for the provision of a new access after for instance change in ownership or use of the building 22A.

In this embodiment, clips 10 are connected to the first cable 90A prior to insertion of the first cable 90A into the first branch pipe 50A. In order to fit into the first branch pipe 50A, the clips 10 are thereto provided in a transport configuration, in which their lateral extension is less than the diameter of the first branch pipe 50A. The clips 10 are suitably attached on locations identified in the inspection step and/or outside locations identified in the inspection step as unsuitable areas. In an alternative embodiment, clips 10 may be applied after insertion of the first cable 90A into the first branch pipe 50A. Then, marking of the first cable 90A for identification of either suitable clip locations or unsuitable areas is preferred. Also in case of attachment of the clips 10 to the first cable 90A prior to insertion into the first branch pipe 50A, marking may be applied as an intermediate step.

The first cable 90A is suitably marked on the basis of the inspection data collected by the inspection robot 80 in step 1. Suitably, the inspection robot identifies areas along the length of the first branch pipe 20A, which areas are to be left free of clips 10. This for instance relates to sharp corners and location at which the first branch pipe 50A is damaged or at which there is a physical transition between a first pipe portion and a second pipe portion. Such unsuitable areas together with a further parameters may then be used to calculate marking positions for the attachment of clips. Other factors suitably contributing to the calculation of the marking positions include a desired distance between neighbouring clips, the number and sharpness of curves, the steepness of the first branch pipe 50A in vertical direction, likely having an impact on the flow speed and therewith the resistance needed to keep the first cable 1A in an accurate position. Also the orientation of curves is suitably identified, so as to ensure that the first cable 90A suitably is provided in the inner side rather than the outer side of a curve in the first branch pipe 20A.

FIG. 1B moreover shows a robot 92, with a cable connection 192 and a lasso tool 93. This lasso tool comprises a suitably shaped aperture, for instance in the form of an half cylinder. FIG. 2A shows a cross-sectional drawing of the robot 92 in more detail. FIG. 2B shows a top view on the robot 92. The robot is provided with a body 180 provided with wheels so as to enable movement in the main pipe 1. It is further provided with a lamp 190 that is located on an upper side of the body 180. The lamp 190 may be equipped to provide light in any desired form, including spectroscopic light of a certain frequency. In this embodiment, the lamp 190 is provided with a reflector present within the illuminated area, so as to provide a better illumination of the pipe. The situation may thus be registered with a camera of the robot 92. The robot 192 is further provided with a bumping body 185, which is in this embodiment shaped in the form of a half moon. The lasso tool 93 encloses an aperture 193 with which an end of the first cable 90A is caught. The robot thereafter draws the first cable 90A to the access point 7. The first cable 90A (or an additional cable inserted in the first branch pipe 50A therewith) is provided with an element or block at its tip. This element has a weight so as to facilitate the insertion of the first cable 90A into and through the first branch pipe 50A. In one embodiment, particularly in combination with the use of an additional cable, the element may be a nozzle for spreading liquid around. This provision of a nozzle allows to carry out a cleaning step simultaneously with the introduction of the first cable 90A. In a further embodiment, not shown, the robot 92 is provided with a clamping section for the first cable 90A. This clamping section is suitably included in the lasso tool 93. It serves to hold the first cable 90A after catching, such that the robot 92 can be moved within the main pipe 10 to the access point 12 without loosing the first cable 90A. The clamping section may be in the form of a robot arm that holds the cable. The clamping section may alternatively be in the form of a narrow space between a first and a second plate, wherein the first cable 90A gets clamped. The narrow space may alternatively be a channel, through which the first cable 90A arrives in a holder. Suitably, the clamping section is located such the first cable 90A is automatically moved towards the clamping section when the robot 92 starts moving. In FIG. 2, this will be the front side (e.g. the side to which the lamp faces).

FIG. 1c shows a third stage in the method. The first cable 90A is herein inserted into the cable trunk 2 through an aperture 3 therein. The cable trunk 2 is in this embodiment provided at the access point 12. The cable trunk suitably comprises several apertures 3. These have been applied on locations identified by the inspection robot 80 in the first step as shown in FIG. 1A. Suitably the second cable 90B (for a location further away from the access point 7) is entered into the cable trunk 2 before the first cable 90A is entered therein. While not shown, use may be made of a further robot equipped with drawing means, so as to draw the cable trunk 2 into the main pipe 1. It is observed that the present embodiment wherein the cable trunk 2 is provided from the access point 7 is an alternative over one method, wherein the cable trunk 2 is provided into the main pipe 1 prior to the arrival of the first cable 90A into the main pipe 1 from the entrance 5A of the first branch pipe 50A. In the latter embodiment, the first cable 90A would be inserted directly into the cable trunk 2. The tip of the first cable 90A may thereto be provided, in one embodiment, with magnetic means, so that the first cable 90A may be drawn through the trunk 2 by magnetic forces. In that embodiment, the robot 92 is suitably provided with a magnet to induce said magnetic force on the tip of the first cable 90A. As shown in FIG. 1c, clips 4 are attached to the cable trunk 2 prior to insertion thereof into the main pipe 1. This is one embodiment, but the clips 4 may also be provided after insertion of the cable trunk 2 into the main pipe. One method for insertion of a cable trunk 2 provided with clips 4 into the main pipe 1 is known from EP1868020A1. A method for the provision of clips 4 after insertion of the cable trunk 2 is for instance known from DE19813728A1. FIG. 1d shows a fourth stage of the method wherein the clips 4, 10 are brought from a transport configuration into an attachment configuration. This transformation of the clips is typically carried out with robots 94, 100. The robot 94 is provided with a cable connection 194. The robot 100 in accordance with the invention is suitably provided with a cable connection (not shown). It will be clear that such cable connections are merely implementations. A cutting tool may be sufficient for carrying out the transformation of the clips, particularly when the clips are provided with a first and a second leg that are kept together with a rope or other means that can be removed by cutting. A closure 8 of the access point 7 is shown in this Figure as well. This transformation of the clips 4, 10, could alternatively be done with a single robot. However, due to the difference in diameter between the main pipe 1 and the first branch pipe 50A, it is deemed preferable to use different robots. FIG. 1E then shows the fifth stage of the present invention, wherein a guide member 40 is introduced into the entrance 5A of the first branch pipe 50A. This guide member 40 is designed so as to guide the first cable 90A to a desired angular position into the first branch pipe 50A. Use is made herein of a robot 197 provided with a cable connection 197. This robot is thereto embodied with a guide member storage facility in which one or more guide members are stored and moved from the access point 7 or another access location to the entrance 5A of the first branch pipe 50A. The design of the robot 97 may be conventional.

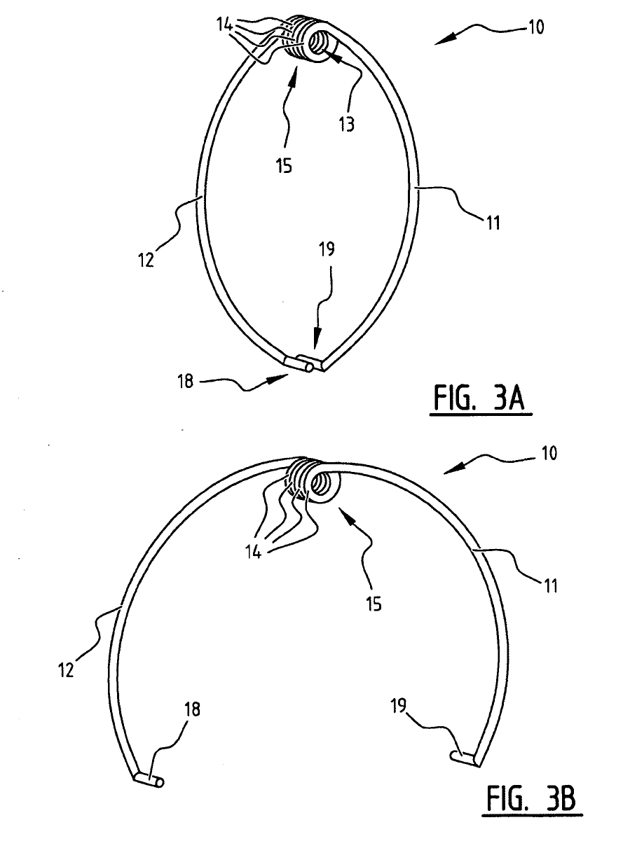

FIG. 3A shows schematically a first embodiment of a cable fastening element 10. The cable fastening element 10 comprises a first leg 11 and a second leg 12 that are mutually coupled over a connection member 15. The first leg 11 and the second leg 12 are mutually displaced over a distance defined by the axially extending connection member 15. This is particularly the case at the intersection between connection member 15 and first and second legs 11, 12. In this embodiment, the connection member 15 is shaped in the form of a winding with a plurality of turns 14. The interior 13 of the turns 14 constitutes a space in which a cable may be positioned, i.e. the cable mounting means are embodied in this embodiment in the turns 14 of the connection member 15. As a result of the construction, the connection member 15 acts as a spring. In the absence of any countermeasures, it would push the first and second legs 11, 12 outside and away from each other. However, the cable fastening element 10 is provided with fixing members 18, 19, which are in this embodiment coupled to legs 11, 12 so as to extend parallel to each other in opposite directions. In the transport configuration in which the cable fastening element 10 is shown in FIG. 3A, the fixing members 18, 19 are coupled together, for instance by a wire (not shown). This prevents that the legs move outward.

FIG. 3B shows the cable fastening element 10 in its fastening configuration. Herein, the fixing members 18, 19 are decoupled, and the first and second legs 11, 12 have moved outwardly. In this embodiment, both the first leg 11 and the second leg 12 have moved outwardly and have made a rotation around the axis defined by the connection member 15 over a substantially equal angle, though in opposite orientation. This embodiment, though preferred, is not necessary. The design of the legs 11, 12 and the connection member 15 may be such that the first leg 11 moves over a larger angle than the second leg 12 or vice versa. Due to the axial displacement of the first and second legs 11, 12 the cable fastening element 10 attains a robustness against swinging over. The fixing members 18, 19 are suitable to support the legs 11, 12 for gripping of the wall of a tube. The axial extension of the connection member 15, and more particularly its subdivision in sections, in this embodiment turns 14 of a winding, furthermore allows bending of the connection member 15. Therewith, the cable fastening element 10 may accommodate corners and curves. It is observed for clarity that alternative embodiments of fixing member may be envisaged. The first and second legs 11, 12 are preferably made of elastic material, but this is not deemed necessary. The first and second legs 11, 12 and the connection member 15 constitute in this embodiment a single body, but that is not deemed necessary either.

FIG. 4 shows in diagrammatical top view a second embodiment of the cable fastening element 10. This cable fastening element 10 is again provided with a first leg 11 and a second leg 12, each with fixing members 19, 18. The cable fastening element 10 is shown fastened to a cable 90. This is achieved by means of clamps 24, 25 part of the connecting member 15. The connecting member further comprises intermediate sections 26, 27 between the axially displaced clamps 24, 25 and the first and second leg 11, 12. The connecting member 15 further comprises a portion extending between said clamps 24, 25 and defining the axial extension. The cable fastening element 10 of this second embodiment provides a strong clamping force to the cable 90, such that it may be attached to the cable prior to insertion thereof into the tube.

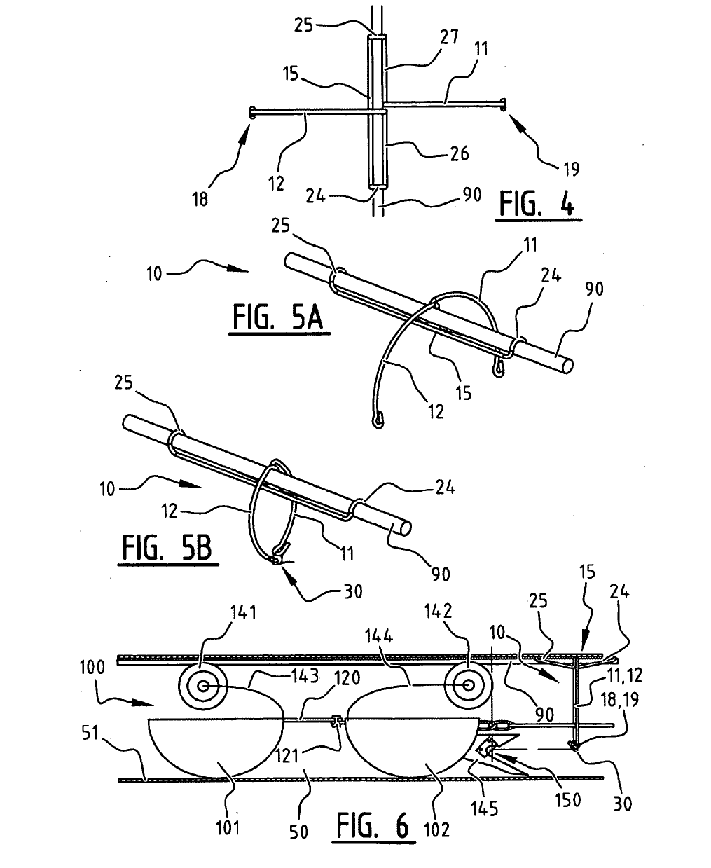

FIGS. 5A and 5B show diagrammatical views of the second embodiment of the cable fastening element 10. FIG. 5A shows the cable fastening element 10 in the fastening configuration; FIG. 5B shows the cable fastening element 10 in the transport configuration. In the latter configuration, the first and second leg 11, 12 are kept together with a rope or wire 30, with is attached to the fixing members 18, 19. The fixing members 18, 19 thereto are suitable embodied in the form of a ring. It will be clear that the first and second leg 11, 12 will be forced into an unnatural state in the transport configuration. Therefore, there is a force to go back to the fastening configuration as shown in FIG. 5A. Hence, upon removal of the rope or wire 30, the fastening element 10 will move elastically and bring itself into the fastening configuration.

FIG. 6 shows a robot 100 according to the invention in a tube 50 with an inner wall 51. In accordance with the invention, the robot 100 comprises a first segment 101 and a second segment 102 that are mutually connected with a bendable coupling member 120. The bendable coupling member 120 is bendable to accommodate a curve or corner in the pipe, which first segment 101 is rotatable with respect to the second segment 102 along the axis 120.

The robot 100 comprises a first segment 101 and a second segment 102 mutually coupled through an bendable coupling member 120, which comprises a hinge point 121. The robot 100 further comprises running wheels 141, 142 each coupled to a segment 101, 102 through wires 143, 144, a cable connection 130 for mechanical reasons, and a knife 150. The knife 150 is positioned such that upon passing the cable fastening element 10, it will cut the rope 30 and therewith deblock the first and second leg 11, 12, so that they can move elastically in view of the now deblocked force. Therewith, a transfer from the transport configuration into the fastening configuration is achieved. In this specific embodiment, the robot 100 is drawn with the cable connection 130. A motor could be present alternatively. The element 145 may be used so as to amend the orientation and follow the curves in the tube 50. The segments 101, 102 each comprise a body. Suitably, these bodies are of sufficient weight to achieve balancing of the robot 100. The bodies herein shift or slide through the tube, such as a ship shifts through water. The running wheels 141, 142 are provided for stability increase, particularly in tube sections that are steeply rising or going down, and/or in curves. Moreover, suitably, the running wheels 141, 142 are provided in pairs. Preferably, the cable 90 is led in between of the pairs of running wheels 141, 142. While this embodiment shows wheels 141, 142 or pairs thereof, it appears sufficient to use a single wheel, or a single pair of wheels. The first wheel is herein preferably located above the knife 145. This provides the best cutting position of the clip. As a result thereof, it appears that further positioning of the clip after bringing it into the fastening configuration is not or substantially not needed any longer. Evidently the provision of positioning tools may be foreseen, also in order to correct errors and/or less optimal fastening situations. If desired, the robot 100 could further be provided with a storage facility for clips. It is not excluded that this robot may be suitable for other types of clips that those in accordance with the invention, even though the use of the present robots in combination with clips of the invention, particularly those of the type that have been mounted to the cable already is deemed most beneficial.

In order to do the operation, in particularly, the cutting of the rope 30, appropriately, the robot 100 should first be positioned at a longitudinal position along the tube 50. The robot 100 may be provided with a break that is suitably coupled to at least one of the wheels 141, 142. Alternatively, a pin arrangement may be present for fixation. Such pin arrangement is for instance attached to the second segment 102, and comprises a first and a second pin with an intermediate rotation element: through rotation, both pins extend in opposed directions, therewith fixing themselves to opposed sections of the wall of the tube. Thereafter, the angular position of the robot is suitably controlled, and if needed modified. Typically, the desired angular position is one wherein the robot is present on the bottom side of the tube 50, i.e. upright. In the present embodiment, wherein the segments 101, 102 comprise balancing weight, for instance with lead, such control and/or modification could even be left out. Then, the knife 150 or alternative cutting tool, or tool for another operation, is aligned with respect to the cable fastening element 10. The robot 100 then will drive, at least in this embodiment, and the rope 30 is cut through by the knife 150. Evidently, instead of a knife 150 directly on one of the segments, here the second segment 102, a robot arm may be envisaged for carrying the knife 150 or other tool.

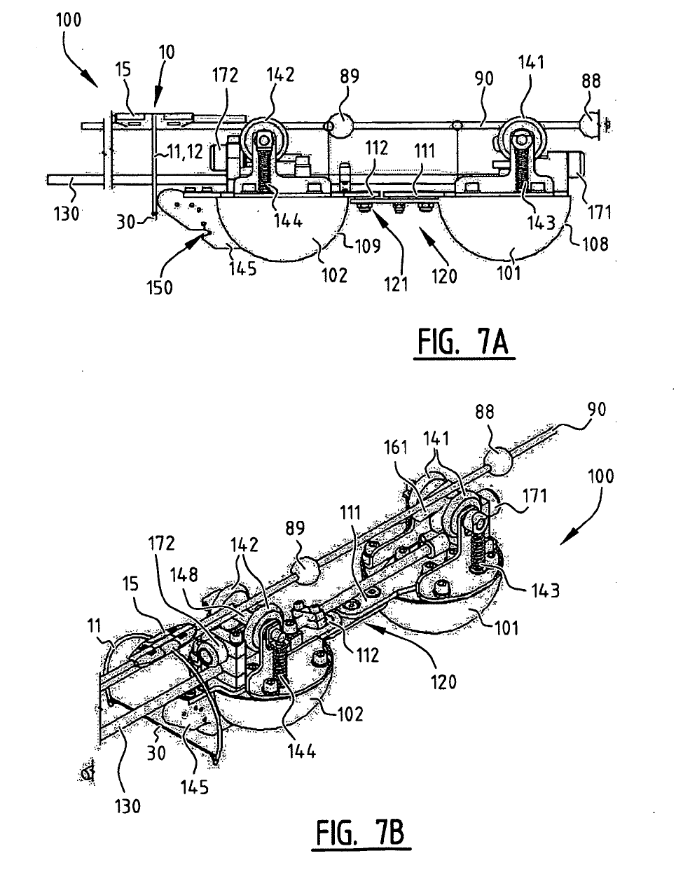

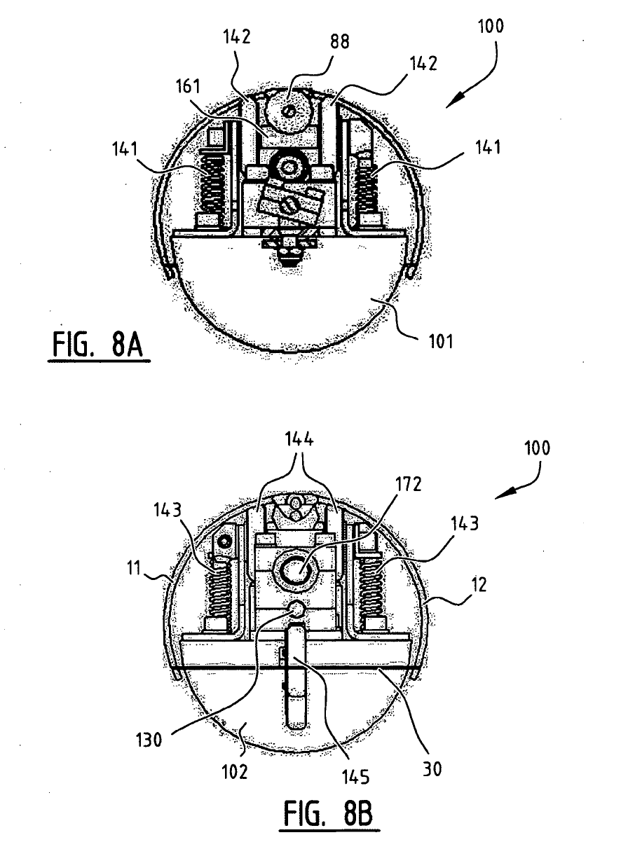

FIG. 7A, 7B, 8A, 8B show a second embodiment of the pipe travelling apparatus 100 according to the invention FIG. 7A is a cross-sectional side view, FIG. 7B is a bird eye's perspective, FIG. 8A is a front side view and FIG. 8B is a rear side view. This second embodiment of the pipe travelling apparatus 100 is highly similar to the first embodiment as shown in FIG. 7. The robot 100 comprises a first segment and a second segment. The first segment comprises a first body 101 provided with a sliding surface 108. The sliding surface 108 is in this embodiment hemispherical, extending both in axial direction as in radial direction relative to the tube (or the cable 90). The sliding surface 108 extends both on the front side (i.e. the side where inspection tool 171 is located), as the rear side opposed thereto. As a consequence thereof, the first segment can travel both forwards and backwards. The sliding surface 108 is moreover continuous in this embodiment. However, embodiments of the first body 101 with a plurality of faces are not excluded.

A first shaft 111 is connected to the first segment. A pair of running wheels 144 is coupled to said first body 101 through a spring 143, in between of which a cable holding device 161 is present for the cable 90, as is best seen in FIG. 7B. In this FIG. 7B, the cable holding device 161 is in a substantially horizontal orientation, such that the apparatus 100 may pass the first and second blocks 88, 89. This orientation of the cable holding device 161 is particularly intended for backward movement or travelling, i.e. to the left side as shown in FIG. 7A.

The second segment is correspondingly provided with a second body 102, which is provided with a sliding surface 109. Running wheels 142 are coupled to the second body 102 via springs 144. A shaft 112 extends from the second segment and is particularly fixed to the second body 102. The second segment is further provided with an element 145 in which a knife 150 is provided. The second segment is provided with an inspection tool 172, while the first segment is provided with an inspection tool 171, for instance a camera. Finally, an axis 148 between the running wheels 142 is further used as a support for the cable 90, therewith constituting a cable holding member.

The first and second shaft 111, 112 are part of a bendable coupling member 120, i.e. a connection along an axis and comprising a bending or hinge point 121. In the present embodiment, the hinge point is located asymmetrically, which means not in the middle between the first and the second segment. In this embodiment, the hinge point 121 is located more closely to the second body 102. The shafts 111, 112 are stiff and do not allow rotation along the axis through the bendable coupling member 120. Merely, bending, i.e. rotation, in the horizontal plane is allowed. A driving cable 130 is also shown, which is sufficiently flexible to allow bending around hinge point 121.

The FIG. 7A,7B moreover show a cable 90, with blocks 88, 89. The distance between blocks 88, 89 is rather small in this embodiment, which is not important. It is however relevant that such blocks 89 may be used for bringing the tip of the cable into the sewer or main pipe, where the cable may be picked up by robot 92 as shown in FIG. 2A, 2B.

FIG. 7A, 7B, 8B furthermore a cable fastening element 10, with first and second leg 11, 12 and an axially extending member 15. A rope 30 is present between the two legs 11, 12. This rope 30 may be cut with the knife 50 of the travelling apparatus, when moving in the backwards direction. After cutting the rope 30, the pipe travelling apparatus 100 may pass between the legs 11, 12 of the cable fastening element 10. The shown cable fastening element 10 constitutes effectively a further embodiment different from those embodiments shown in the FIGS. 3A-3B and 4-5B. According to this embodiment, the axially extending member 15 of the cable fastening element is embodied as a separate element, rather than being part of a continuous fastening element embodied as a metal wire. The axially extending member 15 more precisely comprises a preformed part, for instance a plastic body obtained by insert moulding or transfer molding, with a groove designed so that a cable fits in. A lid may be provided, for closing the groove after insertion of the cable. This is deemed beneficial so as to minimize the risk of constraints. Rather than providing a separate lid, the axially extending member could be provided with a (covered) channel into which the cable can be inserted. Moreover, such a lid may be given a shape complementary to the inner wall of the pipe, such that the cable fastening element will be hanging stable in its fastening configuration, with the legs apart from each other. The axially extending member is further provided with a second groove into which the legs 11, 12 of the cable fastening element 10 fit. While use could be made of a construction as shown in FIG. 3 or 4, it appears sufficient to use a conventional clip, substantially extending in a single plane, such as for instance shown in FIG. 4 of EP1868020. Rather than being embodied as a groove into which the “clip” may be inserted after formation of the axially extending member, the plastic body could be formed around said “clip”.

1. A pipe travelling apparatus for travelling through a curved sewerage pipe and for performing a task in said pipe is provided, said apparatus comprising:
a first segment and a second segment, each comprising a body provided with a sliding surface for sliding along an inner bottom surface of a pipe, said first and second segment mutually coupled by a bendable coupling member;
a tool suitable for performing said task in the pipe and provided in or to at least one of said first segment and said second segment; and
a driving means coupled to said first and/or second segment.

2. The pipe travelling apparatus according to claim 1, wherein the driving means comprise a driving cable.

3. The pipe travelling apparatus according to claim 1, wherein the sliding surface extends both axially to a front side, to a rear side of the body, as well as radially, relative to said pipe.

4. The pipe travelling apparatus according to claim 3, wherein the sliding surface is continuous and curved.

5. The pipe travelling apparatus according to claim 4, wherein the sliding surface is hemispherical or hemi-ovate.

6. The pipe travelling apparatus according to claim 1, wherein the bendable coupling member comprises a first and a second shaft mutually coupled through a hinge point, the first shaft extending to the first segment and the second shaft extending to the second segment.

7. The pipe travelling apparatus according to claim 1, further comprising a running wheel for running against a top portion of the pipe, said running wheel being coupled to the first segment.

8. The pipe travelling apparatus according to claim 1, wherein said tool is a cable holding device for performing the task of transportation of a cable.

9. The pipe travelling apparatus as claimed in claim 8, wherein the cable holding device comprising a retaining means for pushing a block attached to said cable.

10. The pipe travelling apparatus as claimed in claim 9, wherein the cable holding device can be moved away, preferably by rotation, in order to pass a further block attached to said cable when the apparatus travels in a backward direction.

11. The pipe travelling apparatus as claimed in claim 1, wherein the tool is a cable positioning means.

12. The pipe travelling apparatus as claimed in claim 11, wherein the positioning means are embodied as a knife for cutting a rope extending between a first and a second leg of a cable fastening element.

13. The pipe travelling apparatus as claimed in claim 12, wherein the knife is part of the second segment and located for cutting the rope when the travelling apparatus moves in the backwards direction.

14. Use of the pipe travelling apparatus as claimed in claim 1 for performance of a task at a predefined location in a curved sewerage pipe, particularly for transportation and/or fastening of a cable with cable fastening elements to desired longitudinal positions in such a pipe.

15. The use as claimed in claim 14, comprising the steps of moving forwards and moving backwards within said curved sewerage pipe.

16. A system of a pipe travelling apparatus according to claim 8 and a cable for transportation of the cable into a curved sewerage pipe.

17. The system as claimed in claim 16, wherein the cable is provided with a first and a second block and wherein the pipe travelling apparatus is suitable for travelling forwards and backwards, so as to bring the tip section of the cable into a location where the pipe travelling apparatus itself cannot go.

18. The system as claimed in claim 17, further comprising a further pipe travelling apparatus travelling in another sewerage pipe and suitable for picking up cable by means of the first block.

19. A system of a pipe travelling apparatus according to claim 11 and a cable provided with cable fastening elements for positioning of the cable into a curved sewerage pipe.

20. A method of transporting and optionally positioning a cable into a curved sewerage pipe comprising the steps of:
attaching a first block to the cable in a tip section and a second block to the cable at a location further away from the tip section;
providing a pipe travelling apparatus as claimed in claim 1, comprising a cable holding device provided with retaining means for a block attached to the cable, and laying the cable onto the pipe travelling apparatus, such that the first block rests against the retaining means of the cable holding device;
introducing the pipe travelling apparatus with the cable into the curved sewerage pipe, and moving the pipe travelling apparatus forward, so that the cable is transported into the curved sewerage pipe;
rearranging and/or relocating the retaining means of the cable holding device from an active to a non-operative configuration, so that the pipe travelling apparatus may pass the second block during backward movement;
moving the pipe travelling apparatus backwards, such that the first block becomes free of the cable holding device, and is left in its position, and up to a position where in the second block is in front of the cable holding device;
arranging and/or locating the retaining means back from its non-operative into its active configuration; and
moving the pipe travelling apparatus forwards, wherein the retaining means push against the second block, and the tip section of the cable is transported further to a location where the pipe travelling apparatus itself cannot go.

21. The method as claimed in claim 20, wherein the curved sewerage pipe is a drain pipe extending from an individual building and a main, sewer pipe, and wherein the cable is introduced in the drain pipe at the side of the building, the tip section of the cable being brought into the main sewer pipe.

22. The method as claimed in claim 21, wherein the cable is picked up in the sewer pipe by a further pipe travelling apparatus, catching the first block in the tip section of the cable.

23. The method as claimed in claim 20, wherein the pipe travelling apparatus is further provided with positioning means for a cable fastening element having a first and a second leg and attached to the cable, and wherein said cable fastening element is brought from a transport configuration into a fastening configuration by means of a positioning tool arranging in or to the second segment of the pipe travelling apparatus, and wherein the pipe travelling apparatus thereafter continues moving backwards in between of the first and the second leg of the cable fastening element.
